(19) United States
(12) Patent Application Publication
(10) Pub. No.: US 2016/0208159 A1
(43) Pub. Date: Jul. 21, 2016

(54) DOWNHOLE POLYMERIZABLE CLAY CONTROL AGENT FOR SHALE TREATMENT

(71) Applicant: Halliburton Energy Services, Inc., Houston, TX (US)

(72) Inventors: Zheng LU, Kingwood, TX (US); Kurt W. HOEMAN, Houston, TX (US)

(21) Appl. No.: 14/602,207

(22) Filed: Jan. 21, 2015

(51) Int. Cl. C09K 8/60; E21B 43/16

(52) U.S. Cl. CPC C09K 8/608; E21B 43/16

(57) ABSTRACT

A method of treating a well includes placing a first stream comprising a carrier fluid, a polymerizable small molecule cationic clay control monomer, and an optional polymerization initiator into a fracture in a clay-containing subterranean formation, allowing the small molecule cationic clay control monomer to at least partially adsorb to a portion of the surface of the clay, and polymerizing at least a portion of the adsorbed clay control monomer. A clay stabilizing fluid includes an aqueous base fluid, a polymerizable small molecule cationic clay control monomer, and a polymerization initiator.

### BACKGROUND

The present invention generally relates to the use of polymerizable treatment fluids in subterranean operations, and, more specifically, to the use of polymerizable treatment fluids comprising polymerizable monomer compounds and polymerization initiators, and methods of using these treatment fluids in subterranean operations.

The production of hydrocarbons from subterranean formations is often troubled by the presence of clays and other fines, which can migrate with produced fluids and plug off or restrict the flow of such fluids. The migration of fines in a subterranean formation is generally the result of clay swelling and/or the disturbance of normally quiescent fines by the introduction of water foreign to the formation therein. Typically, the foreign water is introduced into the formation in completing and/or treating the formation to stimulate production of hydrocarbons therefrom such as fracturing, acidizing and other treatments utilizing aqueous fluids.

Clays dispersed throughout oil-producing formations may be described as stacked platelets with a net positive charge associated with the four short dimensional sides and a net negative charge with the two long dimensional faces. It is generally believed that the concept of surface charge may be used to understand the mechanisms involved in swelling inhibition. Since the large negatively charged surface is exposed to the surrounding solution, it attracts cations from the solution. In order to inhibit the swelling phenomenon, minimization of the hydratable surface area of the clay is necessary.

A variety of clay stabilizing agents have been developed and used heretofore to control the ill effects of water on clay and/or other fines in subterranean formations containing hydrocarbons. For example, inorganic polycationic polymers or complexes have been utilized as clay stabilizing agents. Ions contained in the clay are replaced by the inorganic polycationic polymers or complexes thereby transforming the clays into relatively non-swelling forms. Such inorganic polycationic polymers or complexes have been successful in controlling swelling clays, but have various limitations. For example, two commonly used inorganic polycationic polymers are zirconyl chloride (ZrOCl₂) and aluminum hydroxychloride (Al(OH)ₓCl_{y}). Aluminum hydroxychloride requires a cure time after it is placed in the presence of the clay. Also, aluminum hydroxychloride can tolerate only a limited amount of carbonate material in the formation and is removed by contact with acids such as when a subsequent acid treatment of the formation is necessary. Zirconyl chloride is limited in the pH range of the placement fluid and can also be removed by acid under certain conditions.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIGS. 1A,B illustrate the function of the clay control agents according to embodiments of the disclosure.

FIG. 2 depicts an embodiment of a system configured for delivering the compositions comprising treatment fluids of the embodiments described herein to a downhole location.

### DETAILED DESCRIPTION

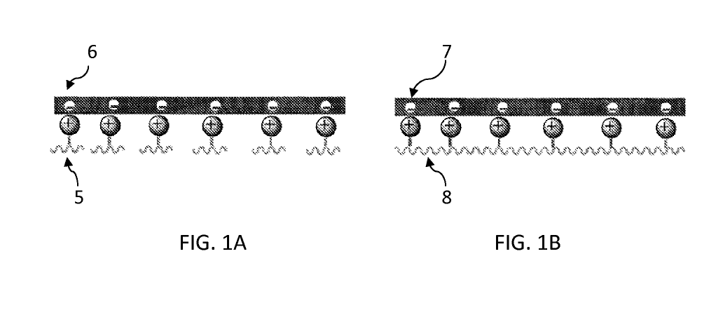

This disclosure describes a small molecule approach to clay control stabilizers which can be polymerized downhole. Deep penetration into rock formations followed by intramolecular crosslinking may increase the permanency of the treatment. In exemplary embodiments, small molecule cationic clay control monomers may be carried with a fluid into the rock formations and due to the small molecular size of these monomers, they may be able to penetrate deeply into low permeability fractures. The kinetics of these cationic molecules adsorbing to the clay surface in the formation is fast enough to provide quick protection. After the adsorption, with down-hole conditions (temperature, pressure, etc.), these monomers can be polymerized so that they will provide permanent protection to the formation. FIG. 1A illustrates a cationic clay control monomer 5 adsorbing onto the negatively charged clay surface 6. FIG. 1B shows the polymerized cationic monomers 8 adsorbed to the clay surface 7 after utilizing the methods in the disclosure.

In some embodiments of the present invention, a well treatment method includes placing a first stream comprising a carrier fluid and a polymerizable small molecule cationic clay control monomer into a fracture in a clay-containing subterranean formation; allowing the small molecule cationic clay control monomer to at least partially adsorb to a portion of the surface of the clay; and polymerizing at least a portion of the adsorbed clay control monomer. In exemplary embodiments, the cationic clay control monomer is a quaternary ammonium salt with at least one polymerizable functional group. The polymerizing may be selected from the group consisting of a ring-opening polymerization, a ring-closing polymerization, and combinations thereof. In another embodiment, the cationic clay control monomer is a diallylammonium monomer. In exemplary embodiments, the cationic clay control monomer is an allyl ammonium compound of the formula (CH₂═CHCH₂)ₙN⁺(CH₃)₄₋ₙX⁻ where X⁻ is an anion which does not adversely react with the formation or the treatment fluid, and n is an integer. In some embodiments, a polymerization initiator is added to the first stream. In an embodiment, the polymerization initiator may be at least one selected from the group consisting of an azo-initiator; a peroxide initiator; a hydroperoxide initiator; dialkyl peroxide; persulfate; and any combination thereof. The polymerization initiator may be selected from 2,2′-azobis(2-amidinopropane.2HCl), t-butylhydroperoxide, and combinations thereof. In exemplary embodiments, the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof. In an embodiment, the cationic clay control monomer is dissolved in the first carrier fluid in an amount in the range of from about 0.15% to about 0.5% by weight of said fluid. In some embodiments, the small molecule cationic clay control monomer is small enough to penetrate into low permeability fractures.

In certain embodiments of the present invention, a method comprises placing a first carrier fluid and a polymerizable small molecule cationic clay control monomer into a fracture in a clay-containing subterranean formation; allowing the small molecule cationic clay control monomer to at least partially adsorb to a portion of the surface of the clay; placing a second stream comprising a second carrier fluid and a polymerization initiator into the formation; and polymerizing at least a portion of the adsorbed clay control monomer. In exemplary embodiments, the cationic clay control monomer is a quaternary ammonium salt with at least one polymerizable functional group. The polymerizing may be selected from the group consisting of a ring-opening polymerization, a ring-closing polymerization, and combinations thereof. In another embodiment, the cationic clay control monomer is a diallylammonium monomer. In exemplary embodiments, the cationic clay control monomer is an allyl ammonium compound of the formula (CH₂═CHCH₂)ₙN⁺(CH₃)₄₋ₙX⁻ where X⁻ is an anion which does not adversely react with the formation or the treatment fluid, and n is an integer. In an embodiment, the polymerization initiator may be at least one selected from the group consisting of an azo-initiator; a peroxide initiator; a hydroperoxide initiator; dialkyl peroxide; persulfate; and any combination thereof. The polymerization initiator may be selected from 2,2′-azobis(2-amidinopropane.2HCl), t-butylhydroperoxide, and combinations thereof. In exemplary embodiments, the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof. In an embodiment, the cationic clay control monomer is dissolved in the first carrier fluid in an amount in the range of from about 0.15% to about 0.5% by weight of said fluid. In some embodiments, the small molecule cationic clay control monomer is small enough to penetrate into low permeability fractures.

Some embodiments of the present invention provide a clay stabilizing fluid comprising: an aqueous base fluid, a polymerizable small molecule cationic clay control monomer, and a polymerization initiator. In exemplary embodiments, the cationic clay control monomer is a quaternary ammonium salt with at least one polymerizable functional group.

In one embodiment, a well treatment system includes a well treatment apparatus, including a mixer and a pump, configured to: place a first stream comprising a first carrier fluid and a polymerizable small molecule cationic clay control monomer into a fracture in a clay-containing subterranean formation; allow the small molecule cationic clay control monomer to at least partially adsorb to a portion of the surface of the clay; place a second stream comprising a second carrier fluid and a polymerization initiator into the formation; and polymerize at least a portion of the adsorbed clay control monomer. In exemplary embodiments, the cationic clay control monomer is a quaternary ammonium salt with at least one polymerizable functional group.

One of the advantages of some embodiments of the disclosure is the ability to tailor the molecular size of the clay stabilizing treatment compounds to the actual fracture size which may provide better protection to the formation. Another advantage is the ability of the compounds to penetrate into low permeability shale formations. A further advantage is the ability of the treatment compounds to act as an instant and permanent clay control agent. Other advantages may be evident to one skilled in the art.

Carrier Fluids

Carrier fluids may be used to deliver the polymerizable small molecule cationic clay control monomers and polymerization initiators into a wellbore. The carrier fluid that is used to deposit the compositions in the fractures may be the same fluid that was used in a prior operation or may be a second fluid that is introduced into the well after the prior operation has concluded. The carrier fluids may include non-aqueous base fluids, aqueous base fluids, foams, and combinations thereof. A first carrier fluid may be used to deliver the polymerizable small molecule cationic clay control monomers to clay in the formation. A second carrier fluid may be used to deliver the polymerization initiators to the adsorbed polymerizable small molecule cationic clay control monomers. The formulation of the second carrier fluid may be the same as the first carrier fluid, or may be a different formulation.

Non-Aqueous Base Fluids

In exemplary embodiments, non-aqueous base fluids may be used in the carrier fluids. Examples of non-aqueous fluids include alcohols such as methanol, ethanol, isopropanol, and other branched and linear alkyl alcohols; diesel; paraffinic solvent; raw crude oils; condensates of raw crude oils; refined hydrocarbons such as naphthalenes, xylenes, toluene and toluene derivatives, hexanes, pentanes; gases such as nitrogen, carbon dioxide, propane, butane, methane, natural gas; and combinations thereof. In certain embodiments, the gases may be used to create commingled foams that make up the non-aqueous base fluids. The fluids may be foamed by combining a compressible gas with the compositions in an amount sufficient to foam the compositions and produce a desired density. Optionally, an effective amount of a foaming agent and an effective amount of a foam stabilizer may be used. In some embodiments, the non-aqueous carrier fluid is present in the treatment fluid the amount of from about 0.1% to about 95% by volume of the treatment fluid, preferably from about 1% to about 90%.

Aqueous Base Fluids

The aqueous base fluid of the present embodiments can generally be from any source, provided that the fluids do not contain components that might adversely affect the stability and/or performance of the treatment fluids of the present invention. The aqueous carrier fluid may comprise fresh water, salt water, seawater, brine, or an aqueous salt solution. In the case of brines, the aqueous carrier fluid may comprise a monovalent brine or a divalent brine. Suitable monovalent brines may include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like.

The aqueous carrier fluid may be present in the treatment fluid in the amount of from about 80% to about 99% by volume of the treatment fluid, typically from about 94% to about 98%.

Cationic Clay Control Monomers

Treatment fluids of the disclosure comprise a polymerizable small molecule cationic clay control monomer. There are three general types of cationic materials useful in this disclosure: single-site cationics, oligocationics, and polycationics. Although cationics derived from sulfur, phosphorous and other elements capable of forming water-soluble cationic sites are effective and included in the embodiments herein, ammonium-based cationics are preferred.

In some embodiments, the cationic clay control monomer is a quaternary ammonium salt with at least one polymerizable functional group. Quaternary ammonium compounds contain ammonium compounds in which one or more of the hydrogen atoms attached to the nitrogen are substituted by organic groups. Some embodiments include allyl ammonium compounds of the formula (CH₂═CHCH₂)ₙN⁺(CH₃)₄₋ₙX⁻ where X⁻ is any anion which does not adversely react with the formation or the treatment fluid. Preferred quaternary monomers include diallyl dimethyl ammonium chloride (where n=2 and X⁻ is Cl⁻) and tetramethyl ammonium chloride.

An additional useful family of monomers in this disclosure is that including 2-oxazoline, which may be polymerized using a ring opening reaction. Non-limiting examples of 2-oxazoline monomers include 2-methyl-2-oxazoline, 2-ethyl-2-oxazoline, 2-(2′-butoxy)ethyl-2-oxazoline, 2-n-propyl-2-oxazoline, 2-isobutyl-2-oxazoline, 2-n-pentyl-2-oxazoline, 2-n-hexyl-2-oxazoline, 2-n-heptyl-2-oxazoline, 2-phenyl-2-oxazoline, 2-benzyl-2-oxazoline, and combinations thereof.

Oligocationics may include di- and polyamines substituted with alkyl groups where one or more of the nitrogens may be quaternized. Other compounds include alkyl, aryl, and alkaryl bis-polyquaternaries wherein two quaternary ammonium nitrogens are connected by various connecting groups having from 2-10 carbon atoms.

Polyquaternary (cationic) compounds may include polymers containing repeating groups having pendant quaternary nitrogen atoms wherein the quaternizing moieties are usually alkyl groups but which can include other groups capable of combining with the nitrogen and resulting in the quaternized state.

In some embodiments, the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof.

In various embodiments, an amount of the polymerizable small molecule cationic clay control monomer present in the treatment fluids is from about 0.025 wt. % to about 1.0 wt. %, alternatively, about 0.15 wt. % to about 0.5 wt. % based on weight of carrier fluid used in the treatment fluid.

Polymerization Initiators

The treatment fluids of the present invention also may include at least one polymerization initiator to polymerize at least a portion of the molecules of the monomers to form a polymer. As used herein, the term “polymerization initiator” includes any molecule, atom, or ion that is capable of initiating polymerization of at least one of the monomers present in the composition.

A variety of polymerization initiators can be used in accordance with the present embodiments. In some embodiments, the polymerization initiators are radical generating organic initiators. In certain embodiments, the radical generating organic initiator is at least one selected from the group consisting of an azo-initiator; a peroxide initiator; a hydroperoxide initiator; dialkyl peroxide; persulfate; and any combination thereof.

In an embodiment, the polymerization initiator is 2,2′-azobis(2-amidinopropane.2HCl). This initiator is a water-soluble cationic azo initiator sold under the trade name V-50™, and available from Wako Pure Chemical Industries, Ltd., Japan. V-50™ may be used along with a diallylammonium monomer, resulting in a ring-closing polymerization as shown below in Reaction 1:

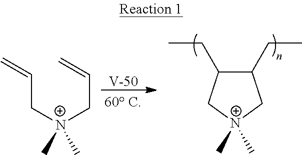

where n is an integer.

Another useful reaction to create polymerized compounds is the cationic ring-opening polymerization (CROP) of 2-oxazoline monomers. Useful initiators for the CROP reaction may include benzyl bromide, methyl triflate, methyl tosylate, and methyl iodide, although other types are possible.

Having the benefit of the present disclosure and knowing the temperature and chemistry of a subterranean formation of interest, one having ordinary skill in the art will be able to choose a polymerization initiator and an amount thereof suitable for producing a desired compressive strength of consolidated proppant particulates.

In some embodiments, the polymerization initiator is optional, that is, the monomers begin to polymerize without a polymerization initiator. In certain embodiments, it is the downhole conditions, such as temperature and or pressure, which cause the polymerization to begin.

Generally, the optional polymerization initiator is present in the current treatment fluids in an amount sufficient to provide a desired degree of polymerization of the monomers. In some embodiments, the polymerization initiator is present in the amount of from about 0.01% to about 5% by weight of the treatment fluid. In other embodiments, the polymerization initiator is present in the amount of from about 1% to about 3% by weight of the treatment fluid.

Polymerization Rate Retarders

In some embodiments, the treatment fluids include a polymerization rate retarder. These may include at least one of the following: potassium ferricyanide; potassium manganicyanide; hydroquinone; derivatives thereof; and combinations thereof. In certain embodiments, the polymerization rate retarder is present in an amount of less than about 5% by weight of the treatment fluid. In other embodiments, the polymerization rate retarder is present in an amount of less than about 3% by weight of the treatment fluid.

Other Additives

In addition to the foregoing materials, it can also be desirable, in some embodiments, for other components to be present in the treatment fluid. Such additional components can include, without limitation, particulate materials, fibrous materials, bridging agents, weighting agents, gravel, corrosion inhibitors, catalysts, biocides, bactericides, friction reducers, gases, surfactants, solubilizers, salts, scale inhibitors, foaming agents, anti-foaming agents, iron control agents, and the like.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the carrier fluid at a subsequent time. After the preblended liquids and the carrier fluid have been combined polymerization initiators and other suitable additives may be added prior to introduction into the wellbore. Those of ordinary skill in the art, with the benefit of this disclosure will be able to determine other suitable methods for the preparation of the treatments fluids of the present invention.

The methods of the present invention can be used in a number of subterranean formation treating operations. For example, the method can be used in conjunction with well completion procedures, sand consolidation procedures, gravel packing procedures, secondary recovery operations, and acidizing, fracturing and other similar operations. In these operations, the stabilizing agent is used to prevent or reduce the swelling of clays and/or migration of fines or combinations thereof. This in turn results in a greater permeability in the subterranean formations involved.

In an embodiment, the clay treatment fluid may be introduced into the wellbore, the formation as a single pill fluid. That is, in such an embodiment, all components of the treatment fluid may be mixed and introduced into the wellbore as a single composition. In an alternative embodiment, the treatment fluid may be introduced into the formation sequentially in multiple components. As will be understood by those of ordinary skill in the art, it may be desirable or advantageous to introduce components of the treatment fluid separately and sequentially.

In still another exemplary embodiment, the separate introduction of at least two of the treatment fluid components may be achieved by introducing the components within a single flowpath, but being separated by a spacer. Such a spacer may comprise a highly viscous fluid which substantially or entirely prevents the intermingling of the treatment fluid components while being pumped into a wellbore. Such spacers and methods of using the same are generally known to those of ordinary skill in the art.

In some embodiments, the present treatment fluids can be used in a subterranean formation having a temperature of up to about 250° F. In some embodiments, the present treatment fluids can be used in a subterranean formation having a temperature ranging between about 75° F. and about 250° F.

Wellbore and Formation

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels, it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone.

As used herein, into a well means introduced at least into and through the wellhead. According to various techniques known in the art, equipment, tools, or well fluids can be directed from the wellhead into any desired portion of the wellbore. Additionally, a well fluid can be directed from a portion of the wellbore into the rock matrix of a zone.

In various embodiments, systems configured for delivering the treatment fluids described herein to a downhole location are described. In various embodiments, the systems can comprise a pump fluidly coupled to a tubular, the tubular containing the polymerizable monomer compositions and/or the polymerization initiator compositions, and any additional additives, disclosed herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

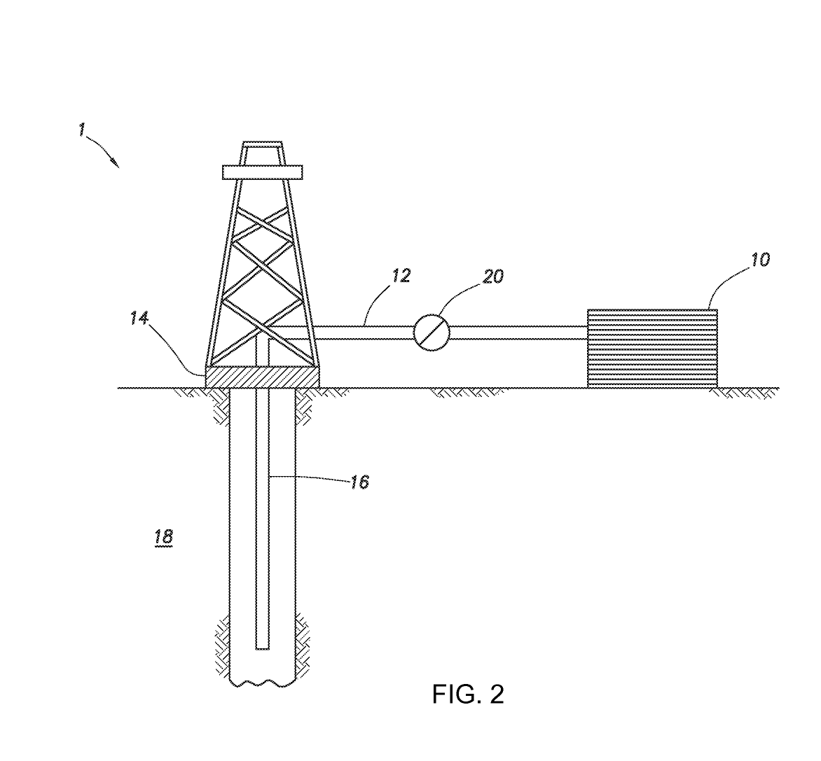

FIG. 2 shows an illustrative schematic of a system that can deliver treatment fluids of the embodiments disclosed herein to a downhole location, according to one or more embodiments. It should be noted that while FIG. 2 generally depicts a land-based system, it is to be recognized that like systems may be operated in subsea locations as well. As depicted in FIG. 2, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 2 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 2.

Embodiments disclosed herein include:

A: A well treatment method including placing a first stream comprising a carrier fluid and a polymerizable small molecule cationic clay control monomer into a fracture in a clay-containing subterranean formation; allowing the small molecule cationic clay control monomer to at least partially adsorb to a portion of the surface of the clay; and polymerizing at least a portion of the adsorbed clay control monomer.

B: A method comprising placing a first stream comprising a first carrier fluid and a polymerizable small molecule cationic clay control monomer into a fracture in a clay-containing subterranean formation; allowing the small molecule cationic clay control monomer to at least partially adsorb to a portion of the surface of the clay; placing a second stream comprising a second carrier fluid and a polymerization initiator into the formation; and polymerizing at least a portion of the adsorbed clay control monomer.

C: A clay stabilizing fluid comprising an aqueous base fluid, a polymerizable small molecule cationic clay control monomer, and a polymerization initiator.

D: A well treatment system comprising: a well treatment apparatus, including a mixer and a pump, configured to: place a first stream comprising a first carrier fluid and a polymerizable small molecule cationic clay control monomer into a fracture in a clay-containing subterranean formation; allow the small molecule cationic clay control monomer to at least partially adsorb to a portion of the surface of the clay; place a second stream comprising a second carrier fluid and a polymerization initiator into the formation; and polymerize at least a portion of the adsorbed clay control monomer.

Each of embodiments A, B, C and D may have one or more of the following additional elements in any combination: Element 1: wherein the cationic clay control monomer is a quaternary ammonium salt with at least one polymerizable functional group. Element 2: further comprising a polymerization initiator in the first stream. Element 3: wherein the polymerization initiator is at least one selected from the group consisting of an azo-initiator; a peroxide initiator; a hydroperoxide initiator; dialkyl peroxide; persulfate; and any combination thereof. Element 4: wherein the cationic clay control monomer is a diallylammonium monomer. Element 5: wherein the polymerization initiator is selected from 2,2′-azobis(2-amidinopropane.2HCl), t-butylhydroperoxide, and combinations thereof. Element 6: wherein the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof. Element 7: wherein the cationic clay control monomer is dissolved in the first carrier fluid in an amount in the range of from about 0.025% to about 1.0% by weight of said fluid. Element 8: wherein the small molecule cationic clay control monomer is small enough to penetrate into low permeability fractures. Element 9: wherein the polymerization initiator is present in the amount of from about 0.01% to about 5% by weight of the treatment fluid. Element 10: wherein the polymerization initiator is present in the amount of from about 1% to about 3% by weight of the treatment fluid. Element 11: wherein the cationic clay control monomer is dissolved in the first carrier fluid in an amount in the range of from about 0.15% to about 0.5% by weight of said fluid. Element 12: further comprising a polymerization rate retarder. Element 13: wherein the polymerizing is selected from the group consisting of a ring-opening polymerization, a ring-closing polymerization, and combinations thereof. Element 14: wherein the cationic clay control monomer is an allyl ammonium compound of the formula (CH₂═CHCH₂)ₙN⁺(CH₃)₄₋ₙX⁻ where X⁻ is an anion which does not adversely react with the formation or the treatment fluid, and n is an integer.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A well treatment method comprising:
placing a first stream comprising a carrier fluid and a polymerizable small molecule cationic clay control monomer into a fracture in a clay-containing subterranean formation;
allowing the small molecule cationic clay control monomer to at least partially adsorb to a portion of the surface of the clay; and
initiating the polymerization of the adsorbed clay control monomer, wherein the initiating step consists of initiating the polymerization by one from the group consisting of a chemical compound, temperature, pressure, and combinations thereof, wherein the method results in greater permeability in the clay-containing subterranean formation.

2. The method of claim 1, wherein the cationic clay control monomer is a quaternary ammonium salt with at least one polymerizable functional group.

3. The method of claim 1, further comprising a polymerization initiator in the first stream.

4. The method of claim 3, wherein the polymerization initiator is at least one selected from the group consisting of an azo-initiator; a peroxide initiator; a hydroperoxide initiator; dialkyl peroxide; persulfate; and any combination thereof.

5. The method of claim 2, wherein the cationic clay control monomer is an allyl ammonium compound of the formula (CH₂═CHCH₂)ₙN⁺(CH₃)₄₋ₙX⁻ where X⁻ is an anion which does not adversely react with the formation or the fluid components, and n is an integer.

6. The method of claim 4, wherein the polymerization initiator is selected from 2,2′-azobis(2-amidinopropane.2HCl), t-butylhydroperoxide, and combinations thereof.

7. The method of claim 1, wherein the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof.

8. The method of claim 1, wherein the cationic clay control monomer is dissolved in the first carrier fluid in an amount in the range of from about 0.025% to about 1.0% by weight of said fluid.

9. The method of claim 1, wherein the small molecule cationic clay control monomer is small enough to penetrate into low permeability fractures.

10. A method comprising:
placing a first stream comprising a first carrier fluid and a polymerizable small molecule cationic clay control monomer into a fracture in a clay-containing subterranean formation;
allowing the small molecule cationic clay control monomer to at least partially adsorb to a portion of the surface of the clay;
placing a second stream comprising a second carrier fluid and a polymerization initiator into the formation; and
initiating the polymerization of the adsorbed clay control monomer, wherein the initiating step consists of initiating the polymerization by one from the group consisting of a chemical compound, temperature, pressure, and combinations thereof, wherein the method results in greater permeability in the clay-containing subterranean formation.

11. The method of claim 10, wherein the cationic clay control monomer is a quaternary ammonium salt with at least one polymerizable functional group.

12. The method of claim 10, wherein the polymerization initiator is at least one selected from the group consisting of an azo-initiator; a peroxide initiator; a hydroperoxide initiator; dialkyl peroxide; persulfate; and any combination thereof.

13. The method of claim 10, wherein the cationic clay control monomer is an allyl ammonium compound of the formula (CH₂═CHCH₂)ₙN⁺(CH₃)₄₋ₙX⁻ where X⁻ is an anion which does not adversely react with the formation, first stream, or the second stream, and n is an integer.

14. The method of claim 10, wherein the polymerization initiator is selected from 2,2′-azobis(2-amidinopropane.2HCl), t-butylhydroperoxide, and combinations thereof.

15. The method of claim 10, wherein the cationic clay control monomer is at least one selected from the group consisting of N,N-dialkylaminoalkyl methacrylate; N,N-dialkylaminoalkyl acrylate; N,N-dialkylaminoalkyl acrylamide; N,N-dialkylaminoalkylmethacrylamide; quaternized N,N-dialkylaminoalkyl methacrylate; quaternized N,N-dialkylaminoalkyl acrylate; quaternized N,N-dialkylaminoalkyl acrylamide; quaternized N,N-dialkylaminoalkylmethacrylamide; vinylamine; allylamine; vinyl imidazole; quaternized vinyl imidazole; diallyl dialkyl ammonium chloride, 2-(Acryloyloxy)ethyl-trimethylammonium chloride; 2-acrylamido)ethyl trimethylammonium chloride; 2-(methacroyloxy)ethyl trimethylammonium chloride; 2-(methacrylamido)ethyl trimethylammonium chloride; 2-(acryloyloxy)ethyl alkyldimethyl ammonium halide; 2-(acrylamido)ethyl alkyl dimethylammonium halide, wherein the alkyl group comprises a C₄-C₂₀ carbon chain, and the halide is chloride, bromide or iodide; 2-oxazolines; and combinations thereof.

16. The method of claim 10, wherein the cationic clay control monomer is dissolved in the first carrier fluid in an amount in the range of from about 0.025% to about 1.0% by weight of said fluid.

17. The method of claim 10, wherein the small molecule cationic clay control monomer is small enough to penetrate into low permeability fractures.

18. A clay stabilizing fluid comprising:
an aqueous base fluid, a polymerizable small molecule cationic clay control monomer, and a polymerization initiator.

19. The fluid of claim 18, wherein the cationic clay control monomer is a quaternary ammonium salt with at least one polymerizable functional group.

20. A well treatment system comprising:
a well treatment apparatus, including a mixer and a pump, configured to:
place a first stream comprising a first carrier fluid and a polymerizable small molecule cationic clay control monomer into a fracture in a clay-containing subterranean formation;
allow the small molecule cationic clay control monomer to at least partially adsorb to a portion of the surface of the clay;
place a second stream comprising a second carrier fluid and a polymerization initiator into the formation; and
polymerize at least a portion of the adsorbed clay control monomer.
